(19) United States
(12) Patent Application Publication
(10) Pub. No.: US 2025/0093962 A1
(43) Pub. Date: Mar. 20, 2025

(54) Hand Gesture Tracking Techniques

(71) Applicant: Ultraleap Limited, Bristol (GB)

(72) Inventors: Pip Timothy Holden Turner, Caerphilly (GB); Peter Nancollis, Chepstow (GB); Rory James Clark, Bristol (GB)

(21) Appl. No.: 18/885,732

(22) Filed: Sep. 15, 2024

Related U.S. Application Data
(60) Provisional application No. 63/582,772, filed on Sep. 14, 2023.
(60) Provisional application No. 63/586,011, filed on Sep. 28, 2023.
(60) Provisional application No. 63/666,601, filed on Jul. 1, 2024.

(51) Int. Cl. G06F 3/01

(52) U.S. Cl. CPC G06F 3/017; G06F 3/011; G06F 3/016

(57) ABSTRACT

Tendrils are a spatial, visually understandable way of understanding the relationship of how an object is constrained in 3D space to another object based on the distance between them, through tension. A tendril can be rendered as a string and can possess soft-body physic like dynamics. When close to breaking, the tension representation becomes key: the tendril may become straight when close to breaking, emphasized by the tendril becoming thinner, and completely disappearing when broken, along with a visual cue (e.g. a particle effect). But if returned back into the distance check soon after the check is broken, the tendril could be repaired. Further, Single-Handed Menus are a way to adapt existing hand menus to be used with just one hand, while keeping the benefits of a hand menu. Further, squish summon allows users to summon far away objects by aiming at them, “squishing” them into nothing (e.g. the scale animating down to zero) as they perform a pose (e.g. moving a hand into a “fist” pose), the object completely disappearing on pose completion, and then the object appearing near the user's hand, as the user's pose returns to idle. The object stays near the user's hand until the pose is weak enough, at which point it detaches from the user's hand, now in the user's direct interaction space.

### RELATED APPLICATIONS

This application claims the benefit of the following three U.S. Provisional Patent Applications, each of which is incorporated by reference in its entirety:
1. U.S. Provisional Ser. No. 63/582,772, filed on Sep. 14, 2023;
2. U.S. Provisional Ser. No. 63/586,011, filed on Sep. 28, 2023; and
3. U.S. Provisional Ser. No. 63/666,631, filed on Jul. 1, 2024.

### FIELD OF THE DISCLOSURE

This application is directed to various forms and functions of hand gesture tracking techniques using an ultrasonic transducer array that produces mid-air haptic effects.

### BACKGROUND

A mid-air haptic feedback system creates tactile sensations in the air. One way to create mid-air haptic feedback is using ultrasound. A phased array of ultrasonic transducers is used to exert an acoustic radiation force on a target. This continuous distribution of sound energy, which will be referred to herein as an “acoustic field”, is useful for a range of applications, including haptic feedback.

It is known to control an acoustic field by defining one or more control points in a space within which the acoustic field may exist. Each control point is assigned an amplitude value equating to a desired amplitude of the acoustic field at the control point. Transducers are then controlled to create an acoustic field exhibiting the desired amplitude at each of the control points.

Tactile sensations on human skin can be created by using a phased array of ultrasound transducers to exert an acoustic radiation force on a target in mid-air. Ultrasound waves are transmitted by the transducers, with the phase emitted by each transducer adjusted such that the waves arrive concurrently at the target point in order to maximize the acoustic radiation force exerted.

By defining one or more control points in space, the acoustic field can be controlled. Each point can be assigned a value equating to a desired amplitude at the control point. A physical set of transducers can then be controlled to create an acoustic field exhibiting the desired amplitude at the control points.

The novel problem to solve herein is finding a solution that allows for a spatial and playful way of representing a one-way distance check between two objects (physical, virtual, or a combination of the two). In this case, a one-way distance check is where an object A has a behavior applied to it based on whether it is within a radius of a target object B. An exemplary behavior to apply, based on this distance check, is a one-way transform constraint where when B moves, A moves with B, but when A moves, B does not move with A. This behavior does not then apply when A no longer is within the radius of B, leaving the radius of B's distance check. Any behavior may be triggered based on this distance check, as long as A is in the radius of B. Equally, a behavior may be triggered when A is outside the radius of B, e.g., A's color stays as red until it is in the radius of B, when it turns blue.

The relationship between these objects may be quite complex and a solution is needed that can:
Convey when an object is connected to another object, or multiple objects;
Convey how close an object is to having its distance check removed;
Convey when an objects distance check is destroyed;
Be expandable to many-to-one and many-to-many relationships; and
Not take up an excessive amount of a user's field of view.

Previously attempted solutions include:
1) Waba by Edwon, 2018. A virtual storage solution in the game “Waba” allows for storage of items in a three dimensional radius, as well as hiding/showing the items. It communicates its spatial constraints using a transparent sphere.
2) Softspace AR, Prototype 4, 2022. Softspace AR is a spatial knowledge graph which uses hands to navigate. It has a strong design language and is focused on displaying relationships between pieces of data.
3) Force-Directed Graph VR, 2017. A spatial graph that represents connections between pieces of data.
4) Noda VR, 2022. A spatial graph similar to Softspace, that allows a user to group information nodes together as a mind map.

Further, extended reality (XR) is a term that refers to the combination of real and virtual environments using computer technology, including Augmented Reality, Virtual Reality, and Mixed Reality. Hand menus are a key interaction for hands when designing in XR. This is a simple tool, acting simply as menus attached to the hand that appear when the user's hand faces the user's face. They are an easy way to give users quick access to common controls for an application that are quick to access and quick to hide. But current hand menu systems are only usable by people with access to both of their hands since a user must keep one hand still and interact with their other hand.

Previously attempted solutions include: www.ultraleap.com/company/news/blog/vr-ar-content-browser/. This is a previous exploration by Ultraleap called Stems. Stems is a content browser designed to be used with hands. The user interface (UI) is manipulated primarily with pinch gestures and may be attached and detached from the hand using a pinch. In Stems, a user pinches a UI that is far away and twists a hand towards the user's face to turn it into a hand menu. A user pinches an attached hand menu and turns a hand away from the user's face to detach the UI from the hand.

Although the continued use of one action (pinch) to interact forms a consistently understandable design language, the pinch combined with constant wrist-twists may become tiring and uncomfortable.

Further, summoning is a common, and key interaction in XR, which is used in a significant percentage of XR applications. It is a necessary as XR users are often constrained in their physical space compared to the virtual space they occupy, meaning that users often need a way to interact with objects that are far away but unreachable physically.

The solution described herein finds a way to cleanly summon an object not in the user's immediate interaction space into their interaction space, in a precise and purposeful manner, tied closely to the user's summoning action. The summon action needs to: (i) be quick to activate; (ii) be memorable to the user; (iii) be tied into the user's current interaction language; and (iv) enable the user to precisely place the object on summoning it.

Prior solutions include:

### Bird3D (dspace.mit.edu/handle/1721.1/142815)

Bird3D controls a 3D cursor for summoning an object. It maps the cursor's current distance from the user to finger curl, and activation to a “tap” of the index finger onto a sphere generated from the current finger curl. To summon, a user moves the cursor to the object the user wants to summon, “tap” to grab it, and then make a fist. The closer the user is to a full fist, the closer the object gets to the user—with a full fist summoning it all the way towards the user. Tap again to unsummon.

Bird3D works well in that it provides a user with an extensive gesture set to control a 3D cursor. But the need to activate an object to interact with makes it more difficult to use and increases cognitive load, making it less memorable.

### Summoning & Superpowers (blog.leapmotion.com/summoning-superpowers-designing-vr-interactions-distance/)

Leap Motion previously explored different ways of summoning objects at a distance—exploring multiple different methods.
1. Selecting an object through a grab, and then using finger curl+palm facing upwards (“come here” gesture) to animate an object into a user's personal space.
2. Selecting an object through a grab, and then while still grabbing, twisting the hand towards the user to animate the object into the user's personal space.
3. Aiming at an object with a user's hand facing upwards, and then curling the user's fingers in a “come here” gesture, causing a ballistic impulse to physically fire the object towards the user, with the user being able to grab it from midair.
4. Using “extendo hands” to literally move the user's hands far away from the user, grab an object, and bring it back.

Method 1 and 2 include an explicit select method, which breaks the interaction down out of one smooth action into multiple actions—adding friction to the summon. Method 3 works well, but it isn't necessarily very precise, meaning that the user has to catch the object as it flies towards them—which could result in an object falling on the ground. Method 4 again works well but requires quite a fundamental shift in the user's interaction toolset, stretching their hands out from their immediate space.

### MRTK/Apple/Meta Windowing Systems

Window systems in spatial operating systems have begun to use a common pattern to bring windows towards a user—aim and pinch/grab at a grab handle on a window, and move the user's hand towards the user, translating the window into the user's personal space, the closer the user's hand gets towards the user. This is a common pattern but requires a fair amount of movement to perform.

### Meta−Pinch Summon+Pose Snap (Timestamp 1:27 in the Video on This Page: developer.oculus.com/documentation/unity/unity-isdk-interaction-sdk-overview/?locale=en_GB)

Meta's Interaction SDK provides a summoning method which involves the user aiming at an object, pinching, and the object animating into the user's grip, which turns into a pose-snapped grip around the object.

This works well as a way to bring an object towards a user, snapping it to a grip, but then requires an additional step to precisely place it into the user's interaction space.

### SUMMARY

Tendrils are a spatial, visually understandable way of understanding the relationship of how an object is constrained in 3D space to another object based on the distance between them, through tension.

A tendril can be rendered as a string and can possess soft-body physic like dynamics. Examples of how to achieve this include using Forward And Backward Reaching Inverse Kinematics, (FABRIK), a chain of beads, or an Inverse Kinematics (IK) chain. When close to breaking, the tension representation becomes key: the tendril may become straight when close to breaking, emphasized by the tendril becoming thinner, and completely disappearing when broken, along with a visual cue (e.g. a particle effect). But if returned back into the distance check soon after the check is broken, the tendril may be repaired.

Tendrils may break in different ways: they can fade out of existence, break at a stiff IK link, or become detached from object A and float freely while still attached to object B. If a broken tendril exists as a new object moves towards it and enters the distance check, the broken tendril may respond to show the potential of the distance check forming by, for example, animating towards the incoming object, or attaching itself once the incoming object enters the distance check.

Further, hand menus are an often-used XR interaction paradigm of attaching menus to a hand. Indeed, Ultraleap's XR Design Guidelines state “When you anchor a small set of controls to the palm, side of the hand or wrist, users can access them more easily because they have a better sense of where it is in space relative to their own hand. It also allows the features to be accessed easily at any time, while still being hidden when the user is interacting with objects.” Single Handed Menus are a way to adapt existing hand menus to be used with just one hand, while keeping the benefits of a hand menu.

Further, squish summon allows users to summon far away objects by aiming at them, “squishing” them into nothing (e.g., the scale animating down to zero) as a user performs a pose (e.g., moving a user's hand into a “fist” pose) with the object completely disappearing on pose completion. The object then appears near the user's hand, as the user's pose returns to idle. The object stays near the user's hand until the pose is weak enough, at which point it detaches from the user's hand and is now in the user's direct interaction space.

This invention differs from previous attempted solutions in that it provides a progressive way to both select and summon an object through the metaphor of squishing rather than a discrete action. This allows a playful action that continuously provides feedback to the user as the user progresses through actions—in this case the object becoming “squished” as a user select it and “unsquished” as a user summons it. Other visualizations are possible as discussed above.

This progressive feedback is especially powerful as it can be paired with pose detection, which, if the user understands the pose, they need to make in order to interact with the object, intuitively suggests to the user when the object they are interacting with will be selected or summoned. This also allows the entire action to be performed in one fluid motion—moving into, and out of, a pose.

### BRIEF DESCRIPTION OF THE DRAWINGS

The accompanying figures, where like reference numerals refer to identical or functionally similar elements throughout the separate views, together with the detailed description below, are incorporated in and form part of the specification, serve to further illustrate embodiments of concepts that include the claimed invention and explain various principles and advantages of those embodiments.

FIG. 1 shows a schematic of a tendril interaction.

FIG. 2 shows a state diagram of a tendril interaction.

FIG. 3 shows a schematic of a single-handed menu interaction.

FIG. 4 shows another schematic of a single-handed menu interaction.

FIG. 5 shows another schematic of a single-handed menu interaction.

FIG. 6 shows another schematic of a single-handed menu interaction.

FIG. 7 shows a state diagram of a single-handed menu interaction.

FIG. 8 shows a cone-casting interaction.

FIG. 9 shows a squish summons interaction.

FIG. 10 shows another squish summons interaction.

FIG. 11 shows a schematic of moving an object connected over a hand from one location to a second location.

FIG. 12 shows a schematic of moving an object disconnected over a hand from one location to a second location.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

### I. Spatial Distance Check Visualized Through Tension

This disclosure shows using representations of tension to describe connectivity between objects and communicating state changes in the object relationship through mechanical properties of the connecting body. A novel aspect is the visual representation of the connection between an object and its distance check through a tendril that uses the idea of the limits of tension to communicate when that constraint will be broken.

This disclosure builds upon a tendril's visual language by employing the use of visual tension.

This may be conveyed in the following ways:

Object A has a distance check that applies a behavior while it is within a certain distance of Object B. When A is not close to leaving the distance check, the tendril reflects this by, for example, being visualized as slack and loose.

When A is close to leaving its distance check (e.g., enters the final 5% of the distance check's radius), the tendril reflects that the distance check is close to being lost through tension. For example, the tendril's slack properties are disregarded, and the tendril snaps into a straight line between A and the root of its distance check (B). In this example, the straight line conveys the idea that the tendril has become taut and is close to breaking.

To reinforce the tension at play, B may react in ways such as shrinking in size, as if pulling back on the tendril.

As A continues to move towards its boundary, the tendril conveys the idea that the tendril is close to breaking by, for example, shrinking in thickness.

When A leaves its distance check boundary, the user is notified via, for example, an animation (e.g., a particle effect) appearing at the position where A left the distance check, and the tendril disappears by, for example, shrinking back into the root of the distance check.

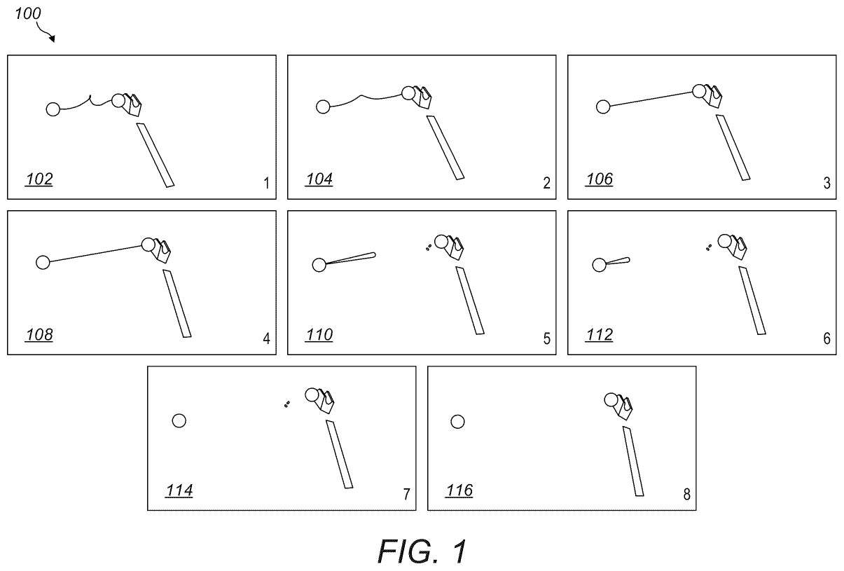

Turning to FIG. 1, shown is a schematic 100 demonstrating removing an object from a distance check, using a tendril. When an object is grasped, the tendril is loose 102, becoming straighter the closer it gets to the distance check's limit 104, before being completely straight close to the limit 106, and reducing its thickness as it gets close to breaking 108, before breaking 110, where the tendril retracts back to the origin of the distance check 112, with a particle effect appearing in the position where the check was broken 110 112 114 and completely disappearing 116.

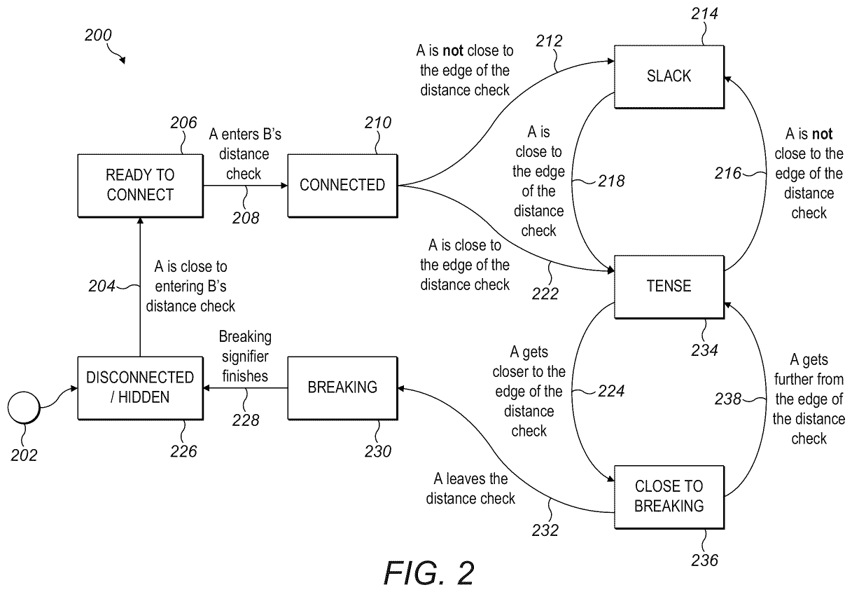

Turning to FIG. 2, shown is an exemplary state diagram 200 of tendrils. The state 202 proceeds to the Disconnected/Hidden stage 226. When A is close to entering B's distance check 204, the state proceeds to the Ready to Connect stage 206. When A enters B's distance check 208, the state proceeds to the Connected stage 210.

At the Connected stage 210, if A is not close to the edge of the distance check 212, the state proceeds to the Slack stage 214. At the Connected stage 210, if A is close to the edge of the distance check 222, the state proceeds to the Tense stage 234.

At the Slack stage 214, if A is close to the edge of the distance check 218, the state proceeds to the Tense stage 234.

At the Tense stage 234, if A is not close to the edge of the distance check 216, the state proceeds to the Slack stage 214. At the Tense stage 234, if A gets closer to the edge of the distance check 224, the state proceeds to the Close to Breaking stage 236.

At the Close to Breaking stage 236, if A gets further from the edge of the distance check 238, the state proceeds to the Tense stage 234. At the Close to Breaking stage 236, if A gets leaves the distance check 232, the state proceeds to the Breaking stage 230.

At the Breaking stage 230, the state proceeds to the Disconnected/Hidden stage 226.

This idea of tendrils may be expanded and built upon to further convey state changes. If a distance check moves a constrained object towards or away from another object, a tendril may animate to straight before moving (to convey the motion) and animate back to slack once stationary.

Tendrils may also represent one-to-many relationships. For example, B may have tendrils connected to all objects it is connected to, or one tendril that represents the average of all such objects, where all objects have a tendril that feeds into one large one.

Tendrils may also represent many-to-many relationships. For example, one tendril represents the average of all objects, where all objects have a tendril that feeds into one large, connected tendril.

Tendrils need not be constantly active. To avoid tendrils becoming visual noise, tendrils may be hidden, or semi-transparent when not moving, fading into existence when a connected object moves, or is close to being moved. For example, this may occur when a user intends to move an object by hovering over it with a hand or by looking at it.

Tendrils may be used to show an object entering into its distance check relationship. This may be done by using the tension metaphor-a slack, unconnected tendril may be attracted to a target—moving towards approaching objects and connecting to them when they come into an activation distance. This may also be reinforced through audio or color signifiers.

The distance check may be broken by interacting with the tendril itself. For example, this may occur by quickly by pulling on the tendrils rather than the object itself—treating the tendril purely like a string and having it “snap” when pulled too far, thereby breaking the distance check. Interacting with the tendril may have a different effect on the connected objects. For example, as the tendril is pulled, the objects don't move, but the tendril does. The tendril is pulled as far as possible before the tension is too much and it snaps, reacting in the same way as when the object is pulled out of the distance check (i.e., shrinking in size, before breaking and returning back to the root object).

Tendrils need not be constrained to pure visuals and can use other forms of feedback to further reinforce the relationship of an object to its distance check.

Tendrils may use audio to reinforce their existing interactions by playing sound effects at each action. Sound effects may occur on activation/deactivation and to reinforce the varying tension. Specifically, an audio cue may begin, and a property of that audio (e.g., pitch) may vary up to the breaking point, at which a separate cue may play (e.g., the sound of a rubber band being stretched and then snapped).

Tendrils may use haptics (e.g., force feedback via mid-air ultrasound) by triggering a sensation (e.g., a pulsed circle) at each action. Sensations may occur at activation/deactivation. To reinforce the varying tension, a sensation may begin, and a parameter of the sensation (e.g., strength, frequency, or the radius of the circle) may vary up to the breaking point, when a separate sensation may be triggered.

Tendrils may operate the same in two dimension as in three dimensions (e.g. with touch, mouse or hand-tracked touch-free input) in the same manner as in three dimensions (i.e., without depth).

Tendrils may operate in a three-dimensional manner on two dimensional screens where an extra input is used for depth translation (e.g., a scroll wheel, distance from screen, or force of touch).

Tendrils may be used to represent other connections beyond distance checks, e.g., their tension may be varied based on the perceived tension of a user as measured by beats per minute, or the progress of a loading bar.

Tendrils may react to when objects are close to entering a distance check.

An example of where tendrils may be applied is in a spatial virtual reality (VR) item organization application called Black Hole Storage. Items may be placed into black holes, which may open and display the items inside of them, and closed to hide the objects. Once in a black hole, a distance check is applied to the child object and the black hole, with a distance constraint behavior applied. Thus, when the black hole moves, the child moves in relation, but when the child moves, the black hole does not.

When a black hole is opened, tendrils animate out, showing that an object is connected to the hole. When a store object is held, its tendril is displayed.

When a black hole is opened, objects may be positioned around the black hole to spatially place them and record their position relative to others, with the tendril showing the item movements. To remove an item from a black hole, the item is pulled out of a distance check, using tendrils to show the relationship breaking.

### II. Single-Handed Menu

Hand Menus are a key interaction for hands when it comes to designing in XR. They are a simple tool: menus attached to a hand that appear when useful, for example, when a user's hand faces a user's face. This is an easy way to give users quick access to common controls for an application. They have the two key behaviors which make them especially convenient: they are available when needed, and hidden when not. But current hand menu systems are only usable by people with access to both of their hands. A user must keep one hand relatively still and interact with their other hand.

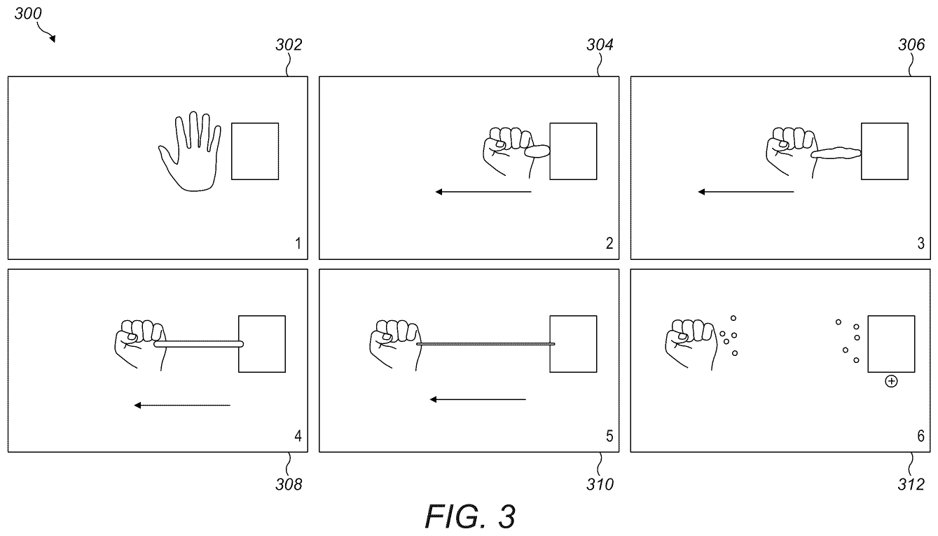

A solution is shown in FIG. 3, a schematic of a detachable menu 300. When the hand menu is active 302, the hand makes a fist 304 and then “pulls” 306 308 (moves away from the hand menu) to switch the hand menu from hand space (attached to the hand) to its new space (e.g., world space). Once detached, the menu can be moved around in its new space (e.g. with a grab ball, a far field ray interaction, or any components that allow a user to position a world-anchored UI). This is represented by a simplified version of the Tendrils Spatial Distance Check Visualization: a line renderer that starts off at a certain thickness, but smoothly reduces its thickness when close to its distance constraint 310, before using an animation 312 to signify that the distance constraint has been broken.

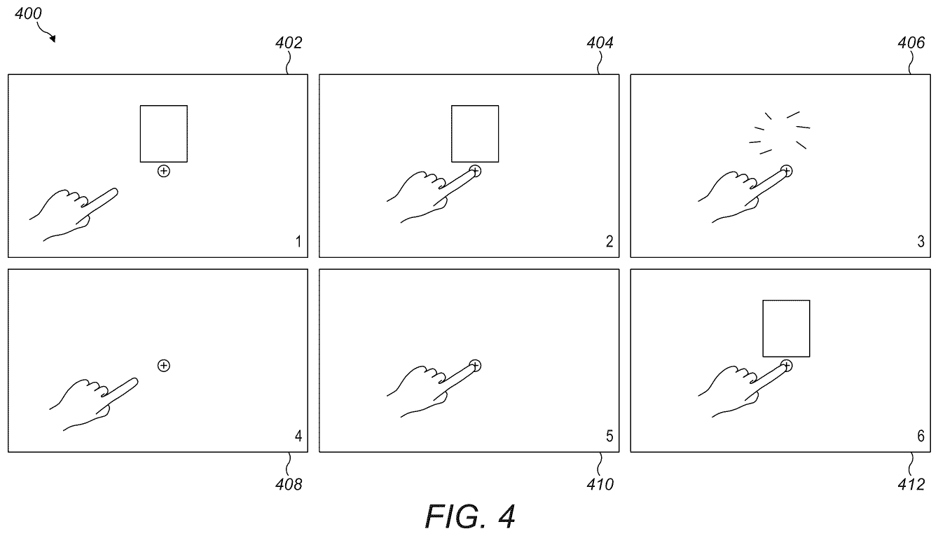

Turning to FIG. 4, shown is a schematic of using a “gizmo” 400: The user taps the gizmo used to move the menu around (e.g. grab ball), to hide 402 404 406 and show 408 410 412 the single-handed menu.

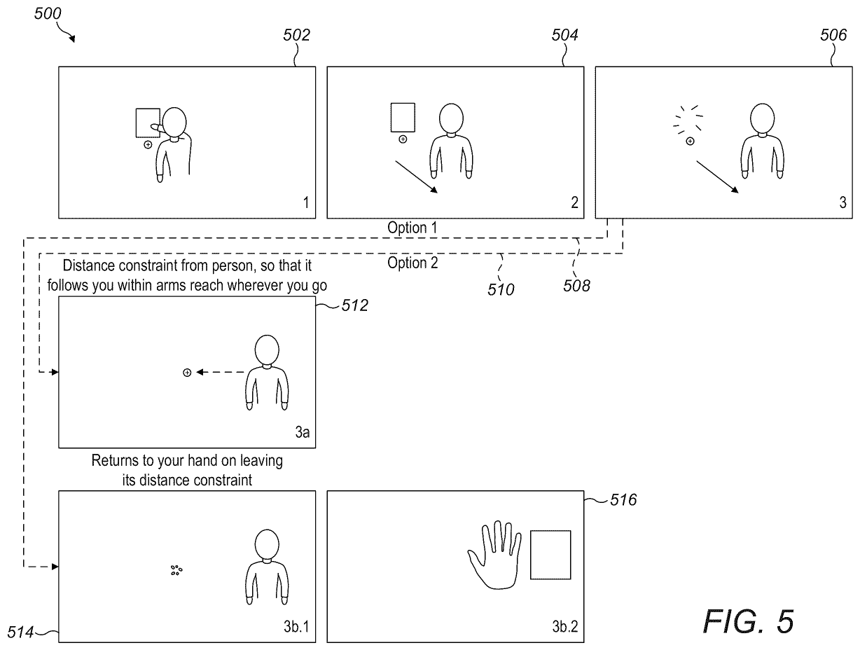

Turing to FIG. 5, shown is a further single-hand menu operation 500 that is available when needed. If a user moves away from a menu 502 504 506 there are two options. Option 1 508 leads to a return of the menu near the user's hand when the hand is raised 514 516. This occurs if a user moves far enough away from the menu such that the user would be unable to reach it. Option 2 510 leads to following the user as the user moves away 512, ensuring that the gizmo or menu is always within a reachable distance.

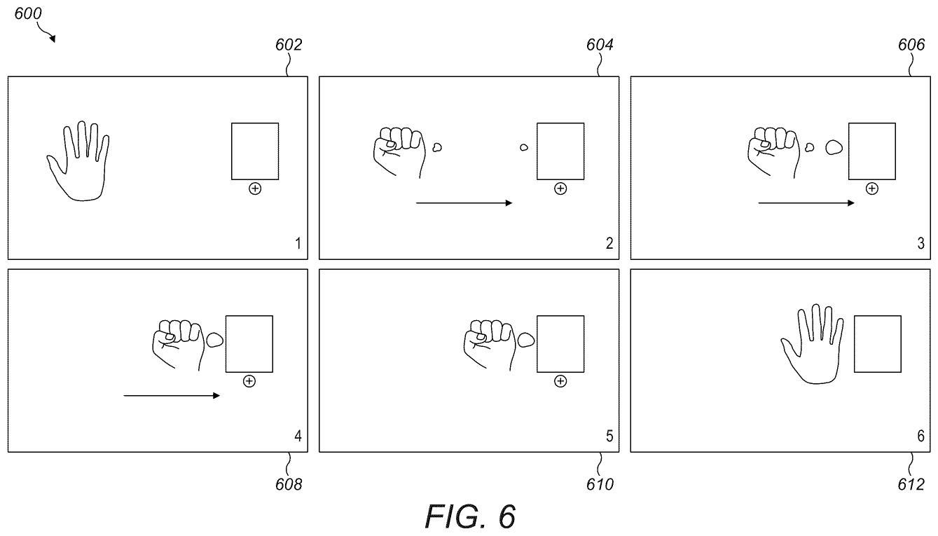

Turning to FIG. 6, shown is a schematic 600 of an attachable menu. Here making a pose 602 when the hand menu would have been active (e.g., palm facing head) causes two attachment anchors to appear 604: one on the hand, one on the menu. By bringing both attachment anchors close enough to each other 606 608, the menu will move back from its current space to hand space, thus reattaching to the hand 610 612.

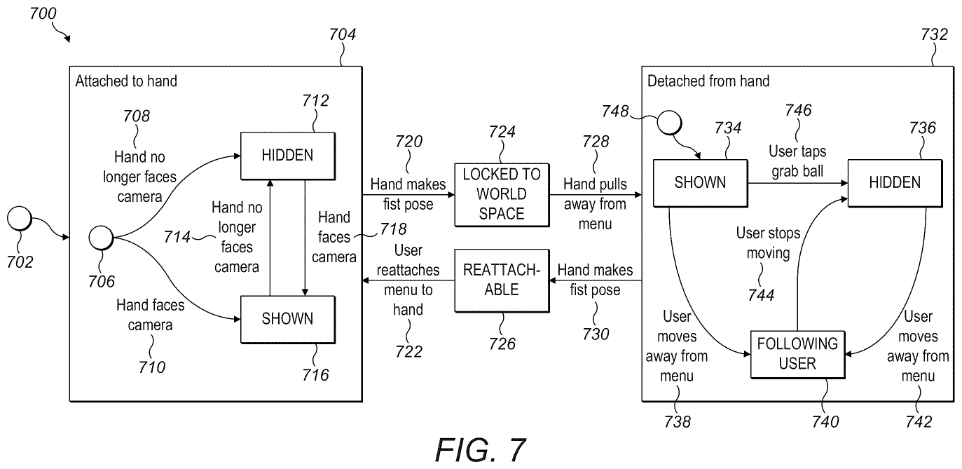

Turning to FIG. 7, shown is an exemplary state diagram 700 of the single-hand menu.

The state 702 begins in the “Attached to hand” group 704 with beginning state 706. If the hand no longer faces the camera 708, the state proceeds to the Hidden stage 712. If the hand faces the camera 710, the state proceeds to the Shown stage 716. At the Hidden stage 712, the state proceeds to the Shown stage 716 if the hand faces the camera 718. At the Show stage 716, the state proceeds to the Hidden stage 712 if the hand no longer faces the camera 714.

In the “Detached from hand” group 704 with beginning state 748 leads to the “Shown” stage 734. If the user taps the grab ball 746, the state proceeds to the “Hidden” stage 736. If the user moves away from the menu 738, the state proceeds to the “Following User” stage 740.

From the “Hidden” stage 736, if the user moves away from the menu 742, the state proceeds to the “Following User” stage 740.

From the “Following User” stage 740, if the user stops moving 744, the state proceeds to the “Hidden” stage 736.

Upon leaving the “Attached to Hand” group 704, the state proceeds to the “Locked to Word Space” stage 724 when the hand makes a fist pose 720. The state then proceeds to the “Detached from Hand” group 732 when the hand pulls away from the menu 728.

Upon leaving the “Detached to Hand” group 732, the state proceeds to the “Reattachable” stage 726 when the hand makes a fist pose 730. The state then proceeds to the “Attached to Hand” group 704 when the user reattaches the menu to the hand 722.

Thus, the single-handed menu aims to adapt the existing hand menu design pattern into an interface that can be used by only one hand and is therefore operable when users only have access to one hand. Its components are as follows:

### A. Detachable Menu

When the hand menu is active, make a pose (e.g., fist 304 in FIG. 3) and makes a specific action (e.g., “pull”: move away from the hand menu) to switch the hand menu from hand space (attached to the hand) to its new space (e.g., world space).

Once detached, the menu can be moved around in its new space (e.g., with a grab ball, or a far field ray interaction, any components which allow a user to position a world-anchored UI).

The action of detaching the menu (e.g., pulling away from the menu) can be done with a space-based distance check. For example, a user must pull a certain distance from the hand menu to detach the hand menu from their hand (FIG. 3). This is represented by a simplified version of the Tendrils Spatial Distance Check Visualization: a line renderer which starts off at a certain thickness, but smoothly reduces its thickness when close to its distance constraint 310, before using an animation 312 to signify that the distance constraint has been broken.

The action of detaching the menu with the same hand it is attached to means that users with access only to one hand are able to use the menu.

### B. Attachable Menu

A user can re-attach the menu back to their hand when detached.

This may be done, for example, in FIG. 6 by making a pose (e.g., a fist 604) when the hand menu would have been active (e.g., palm facing head) that causes two attachment anchors to appear 604, one on the hand, one on the menu. By bringing both attachment anchors close enough to each other, the menu will move back from its current space to hand space, thus reattaching to the hand 612.

### C. Hidden When Not Needed

When the detached hand menu is not needed, it may be unobtrusive to the user's spatial environment.

This may be done, for example, by tapping the gizmo used to move the menu around (e.g., grab ball) to show and hide the Single Handed-Menu (FIG. 4). This retains the behavior of being able to hide the hand menu when not needed. Some examples of hiding could be switching to just an outline of the menu, completely disappearing, or going semi-transparent.

### D. Available When Needed

When the detached hand menu is needed, it should be available to a user. As shown in FIG. 5, this can be done, for example, by returning to a user's hand 514 516 if the user moves far enough away from the menu that the user would be unable to reach it. Another approach may be that the menu follows the user as the user moves away 512, ensuring that the menu is always in a reachable distance.

Single Handed Menus may use controllers in place of hand tracking to achieve the same effect—using a controller input (such as trigger pull or button press) to trigger the detachment interaction.

Haptics may be used to convey its state changes—for example, vibrating each time the menu changes state (e.g., detaching, or hiding). Haptic effects (such as force feedback or midair) may be used in a similar fashion, or used to convey the progress of changing states, varying a parameter (e.g., frequency) as the menu's state changes.

Audio may be used like haptics to reinforce state change, e.g., an elastic band style sound effect as a user pulls away from the hand menu.

Visual shader effects may also be used, e.g., changing color each time the state of the menu changes, or using a dissolve effect on the menu if it disappears.

An alternative visual effect may be used to define the distance boundary (e.g., a circle aligned towards the user that the user has to move his or her hand out of to detach from the menu).

The Single Handed-Menu's novel aspect includes combining previously existing interactions (Hand Menu, Grab Ball, Tendrils) in a way that can adapt the core idea of a hand menu into something that can be smoothly detached from the hand, using only one hand. This can be especially useful for users who may only have access to one hand.

### III. Squish Summons

Squish summon allows a user to aim the user's hand at an object and summon it by squishing it from afar (akin to the action of squishing distant large objects as a child, with a user's hand). Once the user has squished an object, the user is able to “unsquish” it by returning the user's hand to an open configuration.

An object being squish summoned can have multiple stages—for example:
1. IDLE
2. HOVERED
3. SQUISHING
4. SQUISHED
5. UNSQUISHING
6. SUMMONED

IDLE: An object is not being aimed at.

HOVERED: An object is being aimed at.

### Implementation Examples

Aimed at using a ray, such as:
A shoulder->palm position ray;
A wrist offset->pinch position ray;
Eye gaze.

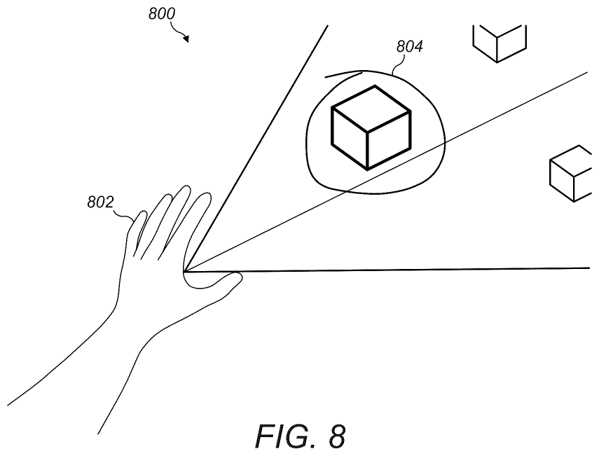

The object could be selected by using a raycasting technique such as:
Simple raycasting, by checking to see if the object intersects with the ray's direction;
Spherecasting, seeing to see if the object intersects with a radius around the ray's direction;
Cone-casting, with the object closest to the middle of the cone being selected. This allows for a forgiving aim, especially at far away objects. Turning to FIG. 8, this schematic 800 shows a hand 802 cone-casting to a faraway object 804.

The object can react when it is hovered, through visual/audio/haptic or other feedback, or a combination of these. For example:
The object could change color;
The object could grow in size;
A haptic controller could vibrate;
A midair haptic device could vibrate the part of the hand that it will be summoned to;
A sound effect could play on hover;
A sound effect could get louder the closer the users gets to hovering, reaching a peak when hovered.

SQUISHING: The summoner begins to move their hand into a pose. Once the pose strength is strong enough, they are “locked” to the object and cannot aim at a different object until their pose is sufficiently weak. As the summoner performs the pose, the object begins to disappear as the pose strength gets stronger.

### Implementation Examples

The object's scale is animated from 1 to 0;
The object's opacity is animated from 1 to 0;
A black hole appears in the object's position, consuming the object when the pose strength becomes strong enough;
User uses a “fist” pose to control the squish strength of the object. User uses a controller's digital trigger to control the squish strength;
The object can react, both when it is initially “locked” on, and as it gets closer to being squished, through audio/visual/haptic feedback;
User uses a controller's force sensors to squish the object, the force varying with the squish strength.

### Squished

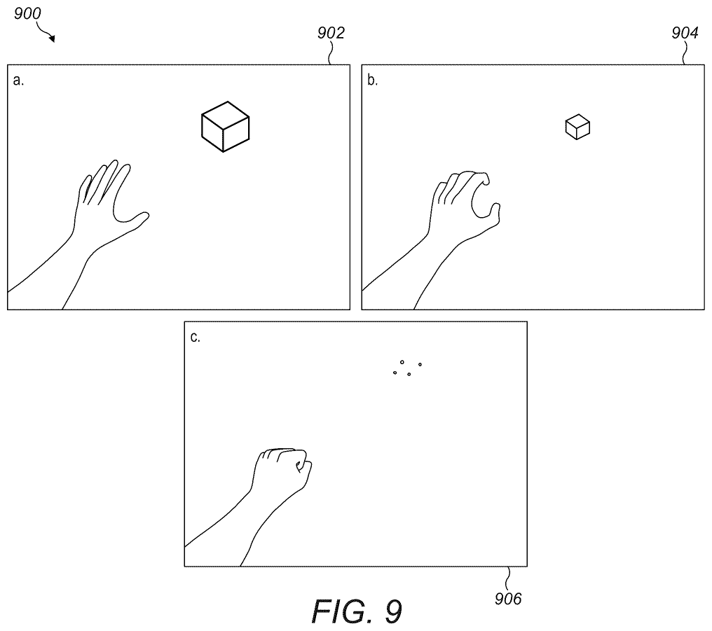

Turning to FIG. 9, shown is a schematic 900 of a squishing stage 902 904 and the squished stage 906.

When the pose reaches a strength of “1”, the object is now squished. It is no longer present at its original location at the squished stage 906. Although the object is now invisible, its position is now in the user's interaction zone.

### Implementation Examples

When the object is squished, it reacts in a visual/audible/haptic manner;
When the object is squished, it can disappear entirely;
When the object is squished its physical appearance could be changed—e.g. smaller in scale or scrunched up.

### Unsquishing

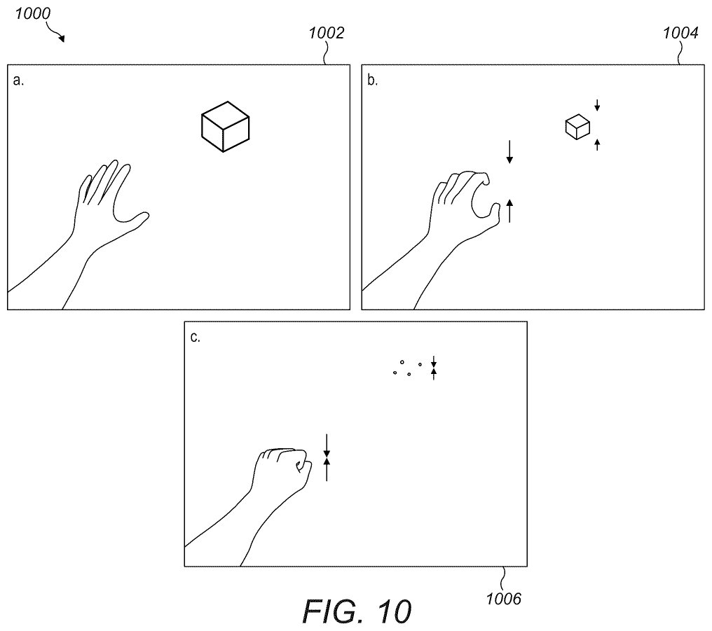

Turning to FIG. 10, shown is a schematic 1000 of an unsquishing stage 1002 1004 and the unsquished stage 1006.

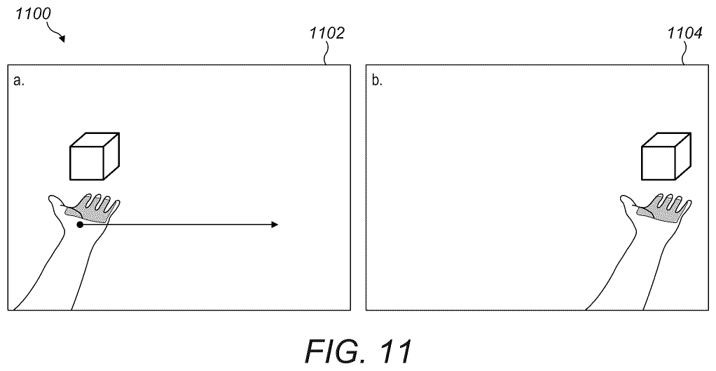

Turning to FIG. 11, shown is a schematic 1100 of moving an object connected over a hand from one location 1102 to a second location 1104.

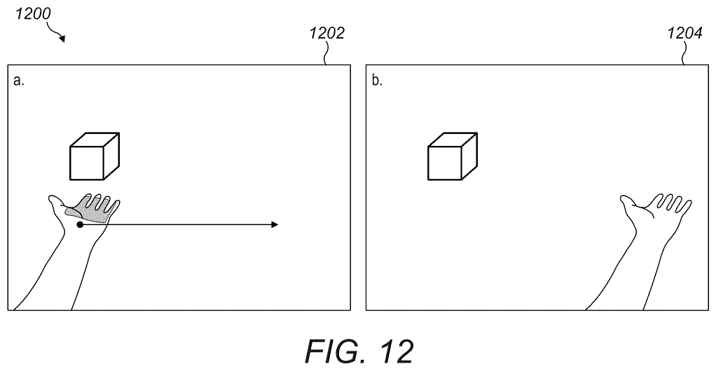

Turning to FIG. 12, shown is a schematic 1200 of moving an object disconnected over a hand from one location 1202 to a second location 1204.

The object unsquishes as the pose strength gets weaker. The object's position is now close to the user. As the object is unsquished it remains at its summoned position.

### Implementation Examples

The object grows in scale above the summoner's palm position as their grab strength gets weaker. This means that the user naturally moves into an “open hand” pose as they summon the object, ready to catch the object if their hand is facing upwards. If the palm is facing a different direction, the user can precisely position the object using the preview of where it will be summoned. The distance the object is positioned from the user can be dictated so that it fits perfectly onto the palm when unsquished, not intersecting with the palm.
While being unsquished, having the object's physics disabled makes it easier to position.
The object can react in a visual/audible/haptic manner as it unsquishes.
The object could move from its original position to its new one as the user's pose strength changes to idle.
The position the object gets summoned could vary from the user's interaction zone, instead summoning to a prescribed space, such as a shelf, body attached position, or virtual storage space.
The object can remain in local space to an object in the user's interaction space in order to stay in the interaction space of the user 1102 1104.

### Summoned

Once the pose is sufficiently weak, the object is at its original size and becomes unfrozen from its summoned position. Its velocity can be modified upon being summoned.

### Implementation Examples

The velocity of becomes as if it has just detached from its summoned position, allowing the object to be “thrown” upon summon.
The object becomes summoned above the palm. If the palm is facing upwards, the user can immediately catch the object. If the palm is facing a different direction, the user can drop the object in a specific position.
When the object is summoned, it reacts in a visual/audible/haptic manner.
In order to become “unfrozen” from its summoned position, the object could return to world space 1202 1204.

### IV. Conclusion

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed

Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A mid-air haptic feedback system comprising:
a phased array of ultrasonic transducers used to exert an acoustic radiation force on a target by defining at least one control point in a space within which an acoustic field exists;
wherein the ultrasonic transducers are controlled to create the acoustic field to exhibit desired amplitude at each of the at least one control point;
a visual representation of a connection between an object and a distance check of the object through a tendril;
wherein the visual representation of the tendril is slack when the object is not close to leaving the distance check of the object;
wherein the visual representation of the tendril is taut when the object is close to leaving the distance check of the object; and
wherein the visual representation of the tendril is deleted when the object leaves the distance check of the object.

2. The system as in claim 1, wherein the object is a real object.

3. The system as in claim 1, wherein the object is a virtual object.

4. The system as in claim 1, wherein the close to leaving the distance check of the object occurs when the object is within 5% of a radius of the distance check.

5. The system as in claim 1, wherein the visual representation of the tendril when the tendril is deleted further comprises a haptic effect.

6. The system as in claim 1, wherein the visual representation of the tendril when the tendril is deleted further comprises a sound effect.

7. The system as in claim 1, wherein the tendril represents an average of least two of the objects.

8. The system as in claim 1, wherein the tendril becomes semitransparent when slack.

9. The system as in claim 1, wherein a sensation begins when the tendril is taut and becomes an increased sensation when the tendril is deleted.

10. The system as in claim 1, wherein when the tendril is taut, the tendril is reduced in thickness.

11. A mid-air haptic feedback system comprising:
a phased array of ultrasonic transducers used to exert an acoustic radiation force on a target by defining at least one control point in a space within which an acoustic field exists;
wherein the ultrasonic transducers are controlled to create the acoustic field to exhibit desired amplitude at each of the at least one control point;
a camera for tracking one hand of a user;
a visual representation of a menu that can be used by the one hand of the user, wherein the visual representation has an attached to hand mode and a detached from hand mode.

12. The system as in claim 11, wherein the attached to hand mode comprises a hidden menu stage and a shown menu stage, wherein the hidden menu stage is activated when the one hand of the user does not face the camera, and wherein the shown menu stage is activated when the one hand of the user faces the camera.

13. The system as in claim 12, further comprising a locked world space stage that is activated when the one hand of the user makes a fist pose.

14. The system as in claim 11, wherein the detached from hand mode comprises a hidden menu stage, a shown menu stage, and a following user stage, wherein the hidden menu stage is activated when the one hand of the user stops moving or when the user taps a grab ball associated with the menu, wherein the shown menu stage is activated when the one hand of the user pulls away from the menu, and wherein the following user stage is activated when the user moves away from the menu.

15. The system as in claim 14, further comprising a reattachable stage that is activated when the one hand of the user makes a fist pose.

16. A mid-air haptic feedback system comprising:
a phased array of ultrasonic transducers used to exert an acoustic radiation force on a target by defining at least one control point in a space within which an acoustic field exists;
wherein the ultrasonic transducers are controlled to create the acoustic field to exhibit desired amplitude at each of the at least one control point;
a camera for tracking one hand of a user;
a visual representation of an object that is locked upon a squishing move by the one hand of the user.

17. The system as in claim 16, wherein a virtual black hole appears at the object's position.

18. The system as in claim 16, wherein opacity of the object is reduced during the squishing move.

19. The system as in claim 16, further comprising:
the visual representation of the object is unlocked upon an unsquishing move by the one hand of the user.

20. The system as in claim 19, further comprising a first haptic effect upon the squishing move and a second haptic effect upon the unsquishing move.
